(19) United States
(12) Patent Application Publication
(10) Pub. No.: US 2026/0134087 A1
(43) Pub. Date: May 14, 2026

(54) THERMAL ATTACK EXPLOIT MITIGATION

(71) Applicant: QUALCOMM Incorporated, San Diego, CA (US)

(72) Inventors: Richard Dominic WIETFELDT, San Diego, CA (US); Philip Michael HAWKES, Valley Heights (AU)

(21) Appl. No.: 18/941,673

(22) Filed: Nov. 8, 2024

(51) Int. Cl. G06F 21/54; G06F 21/56; G06F 21/60

(52) U.S. Cl. CPC G06F 21/54; G06F 21/566; G06F 21/602

(57) ABSTRACT

Systems and techniques are described herein for thermal attack exploit mitigation. For example, a computing device can determine a first temperature of the apparatus; determine the first temperature of the apparatus is within a first temperature range; adjust a security level of the apparatus to a first security level based on the first temperature range; and perform a first security action associated with the first security level.

### FIELD

The present disclosure generally relates to cybersecurity attack mitigation. For example, aspects of the present disclosure relate to systems and techniques for thermal attack exploit mitigation.

### BACKGROUND

Cybersecurity attacks can include various techniques (e.g., exploits) leveraging vulnerabilities in software, hardware, and networks to gain unauthorized access to information or to cause harm to a party (e.g., an individual, company, etc.). The exploits used in cybersecurity attacks can vary widely in scope. For example, exploits can include malware, phishing schemes, denial of service (DoS) attacks, etc. As the internet of things (IoT) connects more devices to networks and more businesses rely on data collection from the devices, businesses are increasingly vulnerable to cybersecurity attacks. Mitigating the effects of cybersecurity attacks have become more essential. Some exploits can take advantage of physical limitations of hardware, such as by causing hardware failures resulting from overheating (e.g., a thermal attack). Failure to mitigate against exploits, such as thermal attacks, can result in data loss, financial theft, and reputational damage to the attacked party. Mitigation techniques can be used to maintain cybersecurity of networks and devices, or to at least reduce (e.g., mitigate) effects of cybersecurity attacks.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In some aspects, an apparatus for temperature exploit mitigation is provided. The apparatus can include at least one memory and at least one processor coupled to the at least one memory and configured to: determine a first temperature of the apparatus; determine the first temperature of the apparatus is within a first temperature range; adjust a security level of the apparatus to a first security level based on the first temperature range; and perform a first security action associated with the first security level.

In some aspects, a method for temperature exploit mitigation is provided. The method can include: determining a first temperature of an apparatus; determining the first temperature of the apparatus is within a first temperature range; adjusting a security level of the apparatus to a first security level based on the first temperature range; and performing a first security action associated with the first security level.

In some aspects, a non-transitory computer-readable medium is provided having stored thereon instructions that, when executed by at least one processor, cause the at least one processor to: determine a first temperature of the apparatus; determine the first temperature of the apparatus is within a first temperature range; adjust a security level of the apparatus to a first security level based on the first temperature range; and perform a first security action associated with the first security level.

In some aspects, an apparatus for temperature exploit mitigation is provided. The apparatus includes: means for determining a first temperature of an apparatus; determining the first temperature of the apparatus is within a first temperature range; means for adjusting a security level of the apparatus to a first security level based on the first temperature range; and means for performing a first security action associated with the first security level.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The preceding, together with other features and aspects, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 illustrates an example implementation of a system-on-a-chip (SOC), in accordance with aspects of the present disclosure;

FIG. 2 illustrates an example device for thermal attack exploit mitigation, in accordance with aspects of the present disclosure;

FIGS. 3A-3C illustrates example thermal attack exploits, in accordance with aspects of the present disclosure;

FIG. 4 illustrates an example security level adjustment based on device temperature, in accordance with aspects of the present disclosure;

FIG. 5 illustrates an example temperature and security level look up table, in accordance with aspects of the present disclosure;

FIG. 6 is a flow diagram for thermal attack exploit mitigation, in accordance with aspects of the present disclosure; and

FIG. 7 illustrates an example computing device architecture of a computing device which can implement the various techniques described herein.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the example embodiments will provide those skilled in the art with an enabling description for implementing an example embodiment. It should be understood that various changes may be made in the function and arrangement of elements without departing from the spirit and scope of the application as set forth in the appended claims.

As mentioned previously, cybersecurity attacks can include various techniques (e.g., exploits) leveraging vulnerabilities in software, hardware, and networks allowing malicious actors to gain unauthorized access to information (e.g., data) or to cause harm. The exploits used in cybersecurity attacks can vary in scope. Some example exploits include injection of malware, phishing schemes, denial of service (DoS) attacks, thermal attacks, etc. As the internet of things (IoT) connects more devices to networks and more businesses rely on data collection from the devices, businesses are increasingly vulnerable to cybersecurity attacks.

Some cybersecurity attacks can use exploits that take advantage of physical limitations of hardware. Thermal attacks are an example of an exploit that can cause failures of critical hardware to harm a network. In some examples, thermal attacks can be performed using software techniques, such as a denial of service (DoS) attack intended to cause a processor, server, device, or component of a device to overheat from processing an unexpected increase in network traffic. In other examples, the thermal attacks can include physical techniques to cause the processor, server, device, or component of the device to overheat, such as physically covering vents preventing air-based cooling or detaching pipes to prevent liquid-based cooling. Further examples of thermal attacks can include using lasers to heat the device, moving the device to a hotter environment (e.g., orienting a device to be in direct sunlight, placing the device in a heated room, etc.), and applying friction to the device.

Failure to mitigate against exploits, such as thermal attacks, can result in data loss, financial theft, and reputational damage to the attacked party. Mitigation techniques can be used to maintain cybersecurity of networks and devices, or to at least reduce (e.g., mitigate) effects of cybersecurity attack. In some devices, performing various security actions can contribute to an overall temperature of the device. Security actions can include measures or responses taken (e.g., performed) by a device to protect information systems, networks, data, and hardware from cybersecurity attacks. For example, security actions can include preventive measures such as maintaining a firewall and executing anti-virus (e.g., anti-malware) software. Other examples of security actions can include monitoring and detection measures, such as maintaining an intrusion detection system to monitor network traffic or maintaining an event management system to analyze data in real-time. Further examples of security actions can include measures for protecting data collected or received by the device, such as encrypting data, partially encrypting data, authenticating data (e.g., testing data integrity, identifying origin of data, etc.), partially authenticating data, reducing resolution of collected data, etc. Additional examples of security actions can include disabling of features of the device or transitioning the device to an idle mode, low power mode, or other reduced power mode.

Security actions, such as encrypting data, can be resource-intensive actions. The use of computer resources (e.g., using processing power of the device) can contribute to heat generated by the device during operation. Selecting different security actions based on a temperature of the device can allow the device to continue operation when the device would otherwise be inoperable due to overheating. Further, adjusting security actions based on temperature of the device can prevent damage to the device caused by overheating, such as damage to a battery of the device.

Systems, apparatuses, electronic devices, methods (also referred to as processes), and computer-readable media (collectively referred to herein as “systems and techniques”) are described herein for thermal attack exploit mitigation. In some aspects, thermal attack exploit mitigation can include adjusting security levels of a device based on a temperature of the device. The device can perform various security actions based on the adjusted security level. Security levels can be an indicator of what types of security actions should be performed by the device or at the device based on the temperature of the device. For example, the security level can be part of a look up table (LUT) mapping security levels and security actions to temperature ranges of the device.

In one such example, when the temperature of the device is less than or equal to 75 degrees Fahrenheit, the device can be set to a first security level (e.g., security level=1 or security level 1). When the temperature of the device is between 75 degrees Fahrenheit and 100 degrees Fahrenheit, the device can be set to a second security level (e.g., security level=2 or security level 2). Further, when the temperature of the device is greater than or equal to 100 degrees Fahrenheit, the device can be set to a third security level (e.g., security level=3 or security level 3). Each of the first security level, the second security level, and the third security level can be associated with a security action or plurality of security actions.

As mentioned previously, security actions can include measures or responses taken (e.g., performed) by a device or component thereof to protect information systems, networks, data, and hardware from cybersecurity attacks. Security actions can include preventative measures (e.g., maintaining a firewall, executing anti-virus software, etc.); monitoring and detection measures (e.g., maintaining an intrusion detection system to monitor network traffic, maintaining an event management system to analyze data in real-time, etc.); or data protection measures (e.g., encrypting data, partially encrypting data, authenticating data, partially or selectively authenticating data, reducing resolution of collected data, etc.). Further examples of security actions can include disabling features, reducing a duty cycle of data transmission of the device, or transitioning the device to an idle mode such as a low-power operation mode.

In some aspects, the first security level, second security level, and third security level can be mapped to temperature ranges of the device based on a look up table (LUT). The look up table (LUT) can be a table generated when calibrating the device (e.g., when the device was designed or manufactured). Each security level can be associated with a security action or plurality of security actions. In some aspects, the look up table can be saved in memory of the device. In some examples, the look up table (LUT) can be generated during operation of the device. For example, the device can determine an amount of power (e.g., wattage) consumed to perform a security action by performing the security action. The device can associate the amount of power consumption with an increase in temperature of the device resulting from performance of the security action. Security actions associated with lower power consumption, and consequently lower temperature increases, can be performed at security levels associated with higher temperature ranges of the device. In some aspects, the security actions for each security level can be preset in the look up table.

For example, the device can include a temperature sensor (e.g., a thermometer) to determine the temperature of the device. The device can adjust the security level of the device based on the temperature. In further aspects, the device can perform various security actions associated with the security level. By adjusting the security actions based on the temperature, the device can perform security actions that consume less power, producing less heat, when the device is at higher temperatures. The adjustment of the security level can allow the device to operate longer than the device would otherwise had the device performed more resource intensive security actions overheating the device.

In some aspects, the device can determine to perform various cooling actions in addition to or instead of the security actions. Cooling actions includes measures the device takes to use cooling hardware to reduce the temperature of the device. For example, the system can include a cooling subsystem which can be triggered based on the temperature of the device (e.g., when the temperature of the device or a component thereof exceeds a predetermined temperature threshold). For example, the device can include a fan. As the temperature of the device increases, the device can increase fan speed of the device to cool the device or components thereof. In another example, the device can include a direct liquid cooling subsystem (e.g., piping, pumps, and a refrigerant). The device can activate the direct liquid cooling subsystem based on the temperature. In some examples, the device can control the pump of the direct liquid cooling subsystem to adjust a flow rate of the refrigerant through the device. In further examples, the device can include performance of liquid immersion cooling. For example, the device can be a server or server bank including a liquid immersion tank. When the device exceeds a predetermined temperature, the device can be automatically immersed in a refrigerant or other coolant.

Various aspects of the present disclosure will be described with respect to the figures.

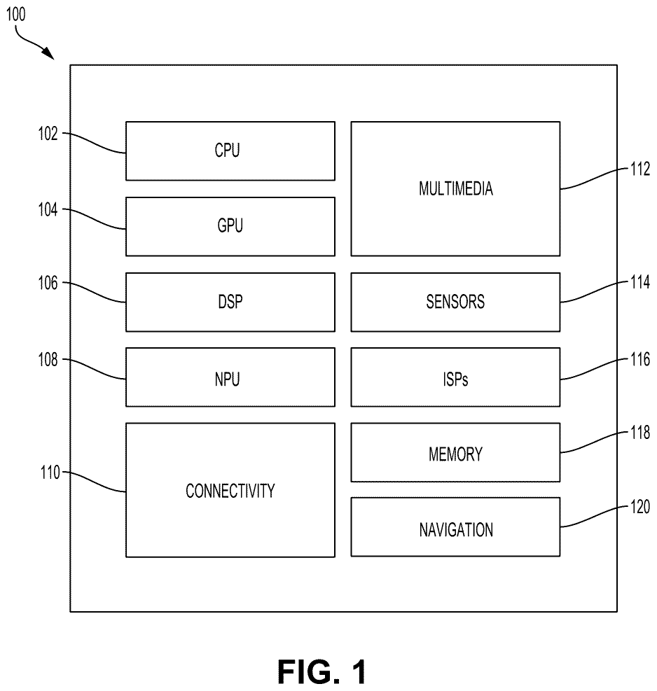

FIG. 1 illustrates an example implementation of a system-on-a-chip (SOC) 100, which may include a central processing unit (CPU) 102 or a multi-core CPU configured to provide a context-aware intelligent cockpit of a vehicle (e.g., processing data from various sensors, generating driver distraction scores, etc.). Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, or may be distributed across multiple blocks. Instructions executed at the CPU 102 may be loaded from a program memory (e.g., at least one memory coupled to the CPU or other component) associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU 108 is implemented in the CPU 102, DSP 106, GPU 104, or a general-purpose processor. The SOC 100 may also include a sensor processor 114, image signal processors (ISPs) 116, and/or navigation module 120, which may include a global positioning system.

The SOC 100 may be based on an ARM, RISC-V (RISC-five), or any reduced instruction set computing (RISC) architecture. In aspects of the present disclosure, the instructions loaded into the general-purpose processor (or CPU 102) can include code to adjust security levels and security actions of a device based on temperature of the device. The instructions loaded into the general-purpose processor, or CPU 102, can also include code to determine a cooling action to perform based on the temperature of the device. The instructions loaded into the general-purpose processor, or CPU 102, can additionally include code to detect cybersecurity attacks based on changes in the temperature of the device. The instructions loaded into the general-purpose processor, or CPU 102, can further include code to generate a look up table for security levels, security actions, and temperature ranges.

In some examples, the SOC 100 can be part of a device for thermal attack exploit mitigation. For example, the SOC 100 can be part of a controller of the device for performing thermal attack exploit mitigation. Various processes and operations for performing thermal attack exploit mitigation can be performed using the SOC 100.

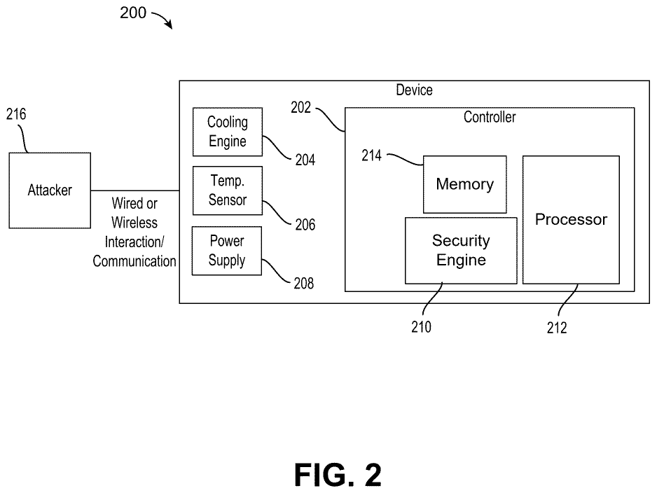

FIG. 2 illustrates an example device 200 for thermal attack exploit mitigation. The device 200 can include various subsystems and components. For example, the device 200 can include a controller 202, a cooling engine 204, a temperature sensor 206, and a power supply 208. The device 200 can use the power supply 208 to power various components of the device 200 such as the controller 202, cooling engine 204, and the temperature sensor 206. The temperature sensor 206 can measure temperatures associated with the device 200 or individual components of the device 200, such as the controller 202. The cooling engine 204 can perform cooling actions based on the temperatures measured by the temperature sensor 206.

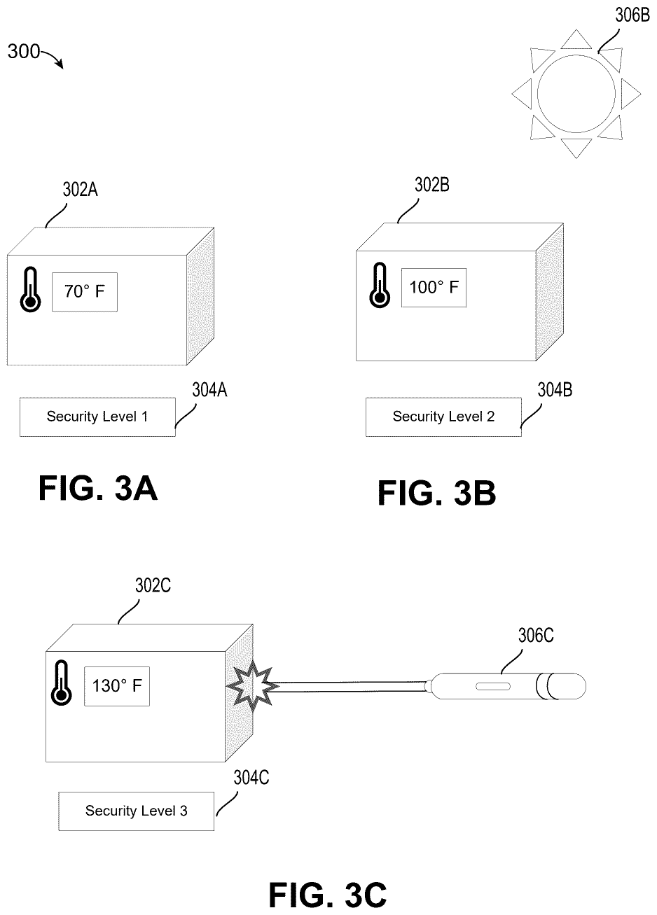

The controller 202 can include a processor 212 (e.g., a central processing unit (CPU), a digital signal processor (DSP), or other type of processor) for executing actions associated with operation of the device 200. For example, the device 200 can be a router. In such an example, the processor 212 can perform actions such as processing data packets, managing network traffic, and executing firmware of the router. An attacker 216 (e.g., an individual performing a thermal attack exploit on the device 200) can perform actions to cause the temperature of the device 200 to increase, such as by performing a denial of service (DoS) attack, shining a laser at the device 200, or moving the device 200 to a hotter environment. Further description of thermal attack exploits is provided in the description of FIGS. 3A-3C.

The controller 202 can further include a security engine 210 and memory 214. The security engine 210 can determine which security actions to perform based the temperature of the device 200 measured by the temperature sensor 206, and a look up table (LUT) stored in memory 214. The look up table can include a table (e.g., a spreadsheet, matrix, or other data object) mapping security levels of the device 200 to temperature ranges of the device 200. For example, the look up table can map a first security level with a first temperature range (e.g., temperatures equal to or less than 75 degrees Fahrenheit) and a second security level with a second temperature range (e.g., temperatures greater than 75 degrees Fahrenheit but less than 120 degrees Fahrenheit). The security engine 210 can use the look up table to determine a security level of the device 200 based on the temperature (e.g., the temperature range in which the temperature of the device 200 is within).

In some examples, the security engine 210 can perform security actions associated with the security level. In further examples, the processor 212 can perform the security actions based on the security level determined by the security engine 210. For example, the security engine 210 or processor 212 can perform security actions such as maintaining a firewall, executing anti-virus software, maintaining an intrusion detection system to monitor network traffic, maintaining an event management system to analyze data in real-time, encrypting data, partially encrypting data, authenticating data, partially or selectively authenticating data, reducing resolution of collected data, etc.

In some examples, the security engine 210 can perform security actions such as transitioning the device 200 to various power states or operation modes. For example, the security engine 210 can transition the device 200 into a low-power mode or idle mode. In the idle mode, the device 200 can disable various functions. For example, when the device 200 is a server in idle mode, the server can wait until it receives a message before communicating with other devices or performing other actions as opposed to actively sending messages. In other examples, the security engine 210 can adjust duty cycle of operations performed by the device 200. For example, the security engine 210 can adjust duty cycles of operations to manage workload, data transmission, and power consumption of the device 200.

Each security level of the lookup table can be associated with a security action or plurality of security actions. In some examples, the look up table (LUT) can be generated during operation of the device 200. For example, the device can determine an amount of power (e.g., wattage) or an amount of energy (e.g. joule) consumed to perform a security action. The device 200 can associate the amount of power consumption or energy consumption with an increase in temperature of the device. In some examples, the device can use an algorithm associating power usage of components of the device 200 with increases in temperature. In such examples, the security engine 210 can perform security actions associated with comparatively lower power consumption at security levels associated with comparatively higher temperature ranges. For example, when the device 200 is set to a first security level associated with a temperature range of less than 70 degrees, the security actions performed by the device 200 can use a greater amount of power than security actions performed by the device 200 when the device 200 is set to a second security level associated with a temperature range greater than 70 degrees.

The cooling engine 204 can determine whether to perform various cooling actions based on the temperature of the device 200. In some examples, the controller 202 (e.g., the processor 212 or security engine 210) can determine whether to perform the various cooling actions and the cooling engine 204 can comprise hardware (e.g., a fan, piping, etc.) to perform the cooling action. In some examples, the cooling engine 204 to perform various cooling actions in addition to or instead of the security actions. For example, the cooling engine 204 can include a fan cooling subsystem which can be activated by the cooling engine 204 based on the temperature of the device (e.g., when the temperature of the device or a component of the device exceeds a predetermined temperature threshold). For example, the cooling engine 204 can include a fan. As the temperature of the device 200 increases, the cooling engine 204 can increase fan speed of the device to cool the device 200. In another example, the cooling engine 204 can include a direct liquid cooling subsystem. The direct liquid cooling subsystem of the cooling engine 204 can include various pipes, pumps, and refrigerants. The cooling engine 204 can pump the refrigerant through pipes of the device 200 to cool the device 200. In some examples, the cooling engine 204 can adjust flow rate of the refrigerant based on the temperature of the device (e.g., faster flow rate for higher temperatures and slower flow rate for cooler temperatures).

In further examples, the device 200 can include hardware for performing liquid immersion cooling (e.g., a liquid immersion tank, refrigerant, etc.). When the cooling engine 204 detects the device 200 temperature is greater than a predetermined temperature threshold, the cooling engine 204 can generate a request for the device 200 to be immersed in the refrigerant of the liquid immersion tank.

FIG. 3A-3C illustrates example thermal attack exploits 300 performed on a device (e.g., device 200 of FIG. 2). For example, FIG. 3A illustrates a device 302A for performing thermal attack exploit mitigation. The device 302A has a temperature of 70 degrees Fahrenheit. At 70 degrees Fahrenheit, the device 302A is set to a first security level 304A. When operating using the first security level 304A, the device 302A can perform various security actions to maintain cybersecurity of the device 302A. For example, the device 302A can be router. When operating using the first security level 304A, the router can encrypt and authenticate all data processed by the router.

FIG. 3B illustrates a first thermal attack exploit 306B. For example, the first thermal attack exploit 306B represents a thermal attack exploit of moving the device 302B to a hotter environment (e.g., placing the device 302B outside in direct sunlight). In such an example, moving the device 302B into direct sunlight can cause an increase in the temperature of the device 302B from 70 degrees Fahrenheit to 100 degrees Fahrenheit. Based on the increase in temperature, the device 302B can adjust the security level of the device 302B to a second security level 304B. When operating at the second security level 304B, the device 302B performs security actions with lower power consumption than the device 302A operating at the first security level 304A. In some examples, the security actions performed by the device 302B can be a subset of a set of security actions performed by the device 302A. For example, the device 302A can encrypt data and authenticate an origin of the data. In contrast, to save power and reduce an amount of heat produced by performing the security actions, the device 302B can encrypt the data but not authenticate the origin of the data.

In some examples, the security actions performed by the device 302B can be lower power consumption alternatives of the security actions performed by the device 302A. For example, the device 302A can encrypt all or substantially all of the data the device 302A collects. In contrast, to save power and reduce the amount of heat produced, the device 302B can encrypt portions of the data (e.g., line-by-line encryption, etc.).

FIG. 3C illustrates a second thermal attack exploit 306C. By way of example, the second thermal attack exploit 306C represents a thermal attack exploit of shining a laser pointer at a device 302C. For example, by shining the laser pointer at the device 302C, the temperature of the device 302C increased from 100 degrees Fahrenheit to 130 degrees Fahrenheit. The device 302C can adjust the security level of the device to a third security level 304C based on the temperature.

In some examples, the security actions performed by device 302C at the third security level 304C can be a subset of the security actions performed by the device 302B at the second security level and a subset of the security actions performed by the device 302A at the first security level 304A. In further examples, the security actions performed by the device 302C at the third security level can be different from any of the security actions performed by the device 302A and the device 302B. For example, the device 302C can transition to an idle mode when operating at the third security level 304C. The device 302C can remain in idle mode until the temperature of the device 302C decreases to within a temperature range associated with the second security level 304B.

In further examples, the device 302B and the device 302C can detect cybersecurity attacks such as the first thermal attack exploit 306B and the second thermal attack exploit 306C based on a change of the temperatures of the device 302B 302C. For example, when the temperature increases at a greater than expected rate, the device 302B 302C can detect the cybersecurity attack, such as a cybersecurity attack using a thermal attack exploit. The device 302B 302C can perform security actions in response to detecting the cybersecurity attack, such as by encrypting data or sending an alert to another device.

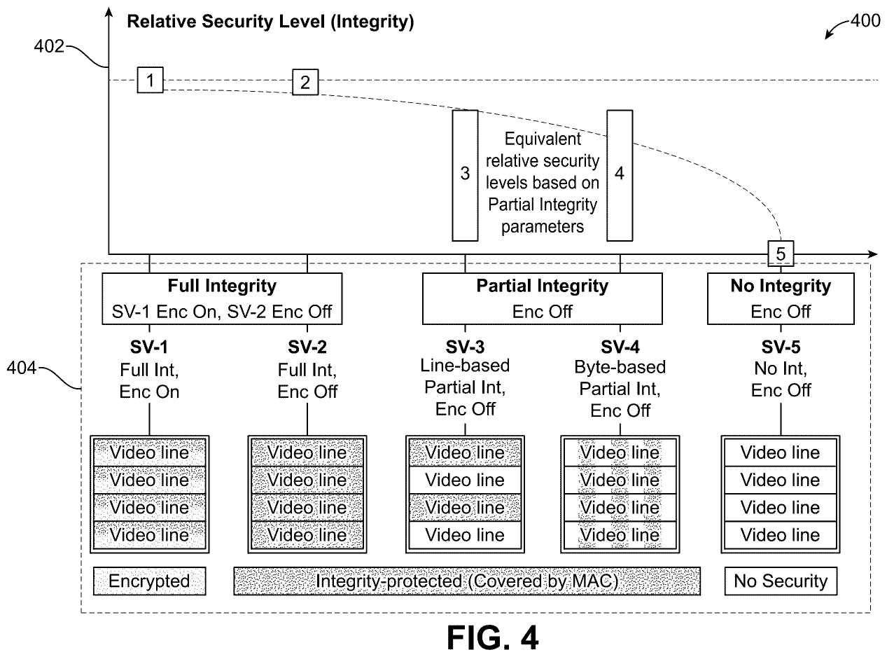

FIG. 4 illustrates an example security level adjustment based on device temperature. For example, FIG. 4 includes a graph 402 illustrating security levels and security actions of a device based on the temperature of the device. For example, the graph 402 illustrates five security levels. The first security level is associated with a higher relative security level (e.g., a security level associated with more security actions or security actions which consume more power to perform relative to other security levels). By way of example, the security levels illustrated by the graph 402 includes a plurality of security actions 404. The plurality of security actions includes encryption of a video stream (e.g., the video line) of data and adjustments to the integrity of the video stream of data. For example, adjustments to the integrity of the video stream of data can include capturing portions of the video stream of data (e.g., line-based partial integrity, byte-based partial integrity, etc.).

At the first security level, the device can encrypt the entire video stream of data. The second security level can be associated with the device operating at a higher temperature than the device operating at the first security level. At the second security level, the device can cease encryption of the video stream to reduce the amount of power consumed by the device thereby reducing the amount of heat produced by the device. The third security level, fourth security level, and fifth security level represent increases in temperature of the device and respective differences in the security actions performed by the device when operating at each respective security level.

For example, the third security level can include no encryption and adjustments to the integrity of the video stream (e.g., the video stream not including one or more portions, such as lines, of a video). The fourth security level can include security actions that further reduce integrity of the video stream. The fifth security level can include applying no security or stopping output or stopping capturing of the video stream entirely (e.g., shutting off a camera associated with the video stream).

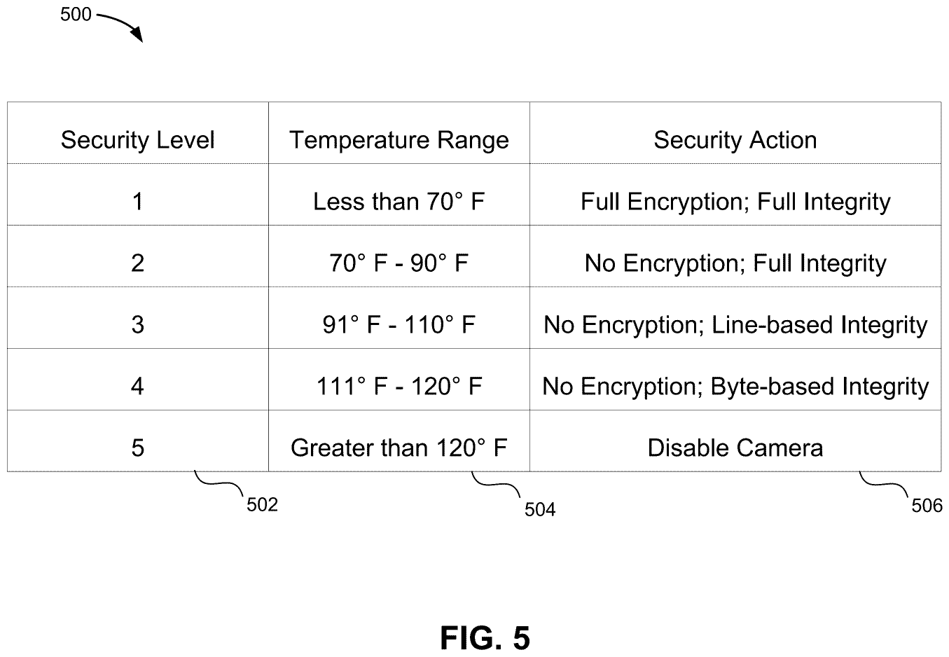

FIG. 5 illustrates an example temperature and security level look up table 500. By way of non-limiting example, the look up table includes three columns. The first column 502 can include a security level of the device. The second column 504 can include a temperature range of the device. The third column 506 can include a security action associated with the security level and the temperature range. In some examples, the third column is part of a second look up table associated with the first column 502.

For example, the look up table 500 includes example temperature ranges and security actions associated with the graph 400 of FIG. 4. In further examples, the three columns can be rearranged. For example, the first column including the temperature range can be the second column, and the second column including security level can be the first column.

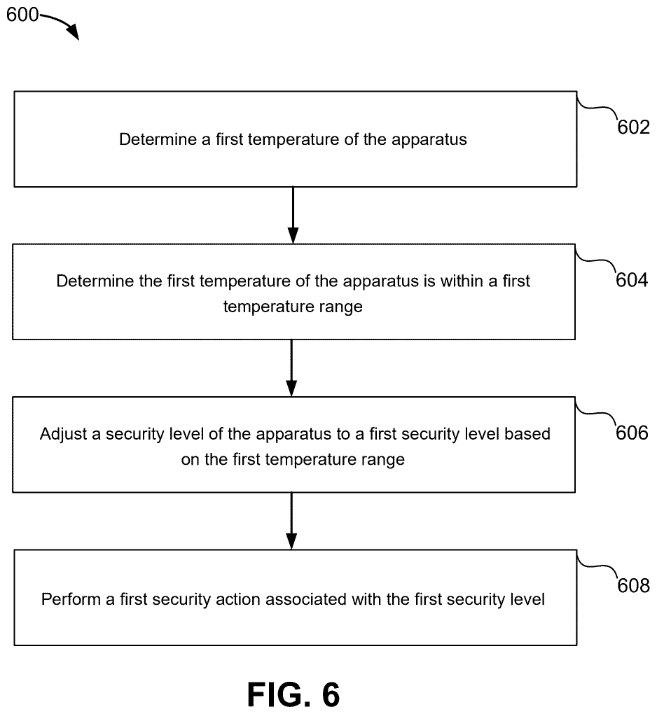

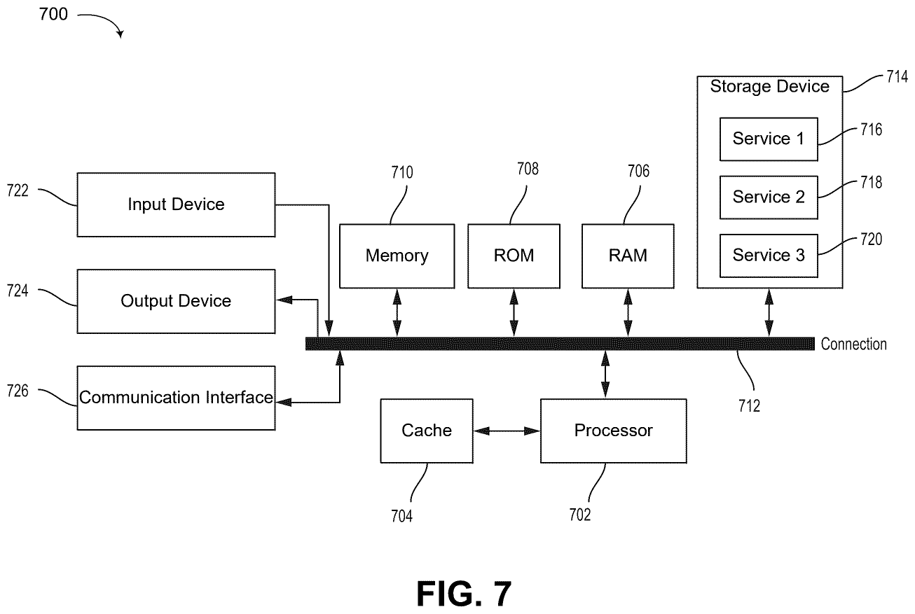

FIG. 6 is a flow diagram illustrating an example of a process 600 for performing thermal attack exploit mitigation. The process 600 can be performed by a computing device (e.g., SOC 100 of FIG. 1, device 200 of FIG. 2, computing device or computing device architecture 700 of FIG. 7, etc.) or by a component or system (e.g., a chipset, one or more processors central processing units (CPUs), digital signal processors (DSPs), graphics processing units (GPUs), any other type of processor(s), any combination thereof, or other component or system) of the computing device or computing device architecture 700. The operations of the process 600 can be implemented as software components that are executed and run on one or more processors (e.g., processor 702 of FIG. 7 or other processor(s)) of the computing device. Further, the transmission and reception of signals by the computing device in the process 600 can be enabled, for example, by one or more antennas and/or one or more transceivers (e.g., wireless transceiver(s)).

At block 602, the computing device (or component thereof) can determine a first temperature of an apparatus. In some examples, the apparatus can be the computing device, a component of the computing device, a server, or another device. In some examples, the computing device is a component of the apparatus. For example, the apparatus or computing device can include a temperature sensor such as a thermometer. The temperature sensor can measure the temperature of the apparatus or individual components of the apparatus.

At block 604, the computing device (or component thereof) can determine the first temperature of the apparatus is within a first temperature range. For example, the apparatus can include various predetermined temperature ranges associated with the apparatus of components of the apparatus stored in memory. For example, the apparatus can include a list, spreadsheet, data structure, or matrix of multiple temperature ranges associated with a processor of the apparatus or associated with a camera of the apparatus. The list, spreadsheet, data structure, or matrix can be stored in memory of the computing device or apparatus. In some examples, list, spreadsheet, data structure, or matrix can be stored off-device, such as at a server, database, repository, etc. The apparatus can compare the first temperature to the predetermined temperature ranges. Based on the comparison, the apparatus can determine a temperature range (e.g., the first temperature range) which the temperature of the apparatus or component is within. For example, the first temperature range can be from 80 degrees Fahrenheit to 100 degrees Fahrenheit and the temperature of the apparatus can be 85 degrees Fahrenheit.

At block 606, the computing device (or component thereof) can adjust a security level of the apparatus to a first security level based on the first temperature range. For example, various security levels of the apparatus can be associated with a temperature range. In such an example, a first security level can be associated with a first temperature range, a second security level can be associated with a second temperature range, etc. When the temperature of the apparatus changes such that the temperature of the apparatus is within a different temperature range, the apparatus can adjust the security level of the apparatus to a security level associated with the different temperature range. For example, the apparatus can detect a change in temperature from 85 degrees to 110 degrees. The apparatus can adjust the security level based on the change in temperature (e.g., based on the updated temperature of the apparatus).

The security levels of the apparatus can include various security actions associated with the security level. For example, at a first security level associated with a temperature range of 80 degrees or lower, the security level can include security actions for the apparatus to perform to protect data associated with the apparatus. In such an example, the security action can be encrypting a video stream or authenticating the video stream. In another example, a second security level can be associated with a temperature range of 80 degrees to 95 degrees. In such an example, the second security level can include security actions performed with fewer processing resources or with less processing power (e.g., less energy, less power, etc.) than security actions associated with the first security level. Generally, the amount of heat produced during operation of a device increases as the device consumes more energy/power or uses more processing resources/power to perform actions. In some examples, the security actions to be performed at security levels associated with higher temperature ranges consume fewer processing resources (e.g., less energy or power) than security actions to be performed at security levels associated with lower temperature ranges.

At block 608, the computing device (or component thereof) can perform the first security action associated with the first security level. For example, the first security action can include encrypting a video stream.

FIG. 7 illustrates an example computing-device architecture 700 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing-device architecture 700 may include, implement, or be included in any or all of the devices, modules, or systems described herein. Additionally, or alternatively, computing-device architecture 700 may be configured to perform process 800, process 900, and/or other process described herein.

The components of computing-device architecture 700 are shown in electrical communication with each other using connection 712, such as a bus. The example computing-device architecture 700 includes a processing unit (CPU or processor) 702 and computing device connection 712 that couples various computing device components including computing device memory 710, such as read only memory (ROM) 708 and random-access memory (RAM) 706, to processor 702.

Computing-device architecture 700 can include a cache of high-speed memory connected directly with, in close proximity to, or integrated as part of processor 702. Computing-device architecture 700 can copy data from memory 710 and/or the storage device 714 to cache 704 for quick access by processor 702. In this way, the cache can provide a performance boost that avoids processor 702 delays while waiting for data. These and other modules can control or be configured to control processor 702 to perform various actions. Other computing device memory 710 may be available for use as well. Memory 710 can include multiple different types of memory with different performance characteristics. Processor 702 can include any general-purpose processor and a hardware or software service, such as service 1 716, service 2 718, and service 3 720 stored in storage device 714, configured to control processor 702 as well as a special-purpose processor where software instructions are incorporated into the processor design. Processor 702 may be a self-contained system, containing multiple cores or processors, a bus, memory controller, cache, etc. A multi-core processor may be symmetric or asymmetric.

To enable user interaction with the computing-device architecture 700, input device 722 can represent any number of input mechanisms, such as a microphone for speech, a touch-sensitive screen for gesture or graphical input, keyboard, mouse, motion input, speech and so forth. Output device 724 can also be one or more of a number of output mechanisms known to those of skill in the art, such as a display, projector, television, speaker device, etc. In some instances, multimodal computing devices can enable a user to provide multiple types of input to communicate with computing-device architecture 700. Communication interface 726 can generally govern and manage the user input and computing device output. There is no restriction on operating on any particular hardware arrangement and therefore the basic features here may easily be substituted for improved hardware or firmware arrangements as they are developed.

Storage device 714 is a non-volatile memory and can be a hard disk or other types of computer readable media which can store data that are accessible by a computer, such as magnetic cassettes, flash memory cards, solid state memory devices, digital versatile discs (DVDs), cartridges, random-access memories (RAMs) 706, read only memory (ROM) 708, and hybrids thereof. Storage device 714 can include services 716, 718, and 720 for controlling processor 702. Other hardware or software modules are contemplated. Storage device 714 can be connected to the computing device connection 712. In one aspect, a hardware module that performs a particular function can include the software component stored in a computer-readable medium in connection with the necessary hardware components, such as processor 702, connection 712, output device 724, and so forth, to carry out the function.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, magnetic or optical disks, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, such as, a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1: An apparatus for temperature exploit mitigation, the apparatus comprising: at least one memory; and at least one processor coupled to the at least one memory and configured to:

determine a first temperature of the apparatus; determine the first temperature of the apparatus is within a first temperature range; adjust a security level of the apparatus to a first security level based on the first temperature range; and perform a first security action associated with the first security level.

Aspect 2: The apparatus of Aspect 1, wherein the at least one processor is configured to: determine a second temperature associated with a change in temperature of the apparatus; determine the second temperature of the apparatus is within a second temperature range, the second temperature range associated with temperatures that are higher than temperatures of the first temperature range; adjust the security level of the apparatus to a second security level based on the second temperature range; and perform a second security action associated with the second security level, wherein performance of the second security action uses less processing power than performance of the first security action.

Aspect 3: The apparatus of Aspect 2, wherein the first security action and the second security action include at least one of encryption of data, partial encryption of data, authentication of data, partial authentication of data, reduction of collected data resolution, or transition of the apparatus to an idle mode.

Aspect 4: The apparatus of any of Aspects 2 to 3, wherein the at least one processor is configured to: detect a cybersecurity attack based on a change from the first temperature to the second temperature.

Aspect 5: The apparatus of any of Aspects 1 to 4, wherein the at least one processor is configured to: determine a cooling action based on the first temperature and the first security action; and perform the cooling action.

Aspect 6: The apparatus of Aspect 5, wherein the cooling action includes at least one of activation of a fan, adjustment of a fan speed, activation of direct liquid cooling, or performance of liquid immersion cooling.

Aspect 7: The apparatus of any of Aspects 1 to 6, wherein the apparatus is a server.

Aspect 8: The apparatus of any of Aspects 1 to 7, wherein the first security action includes a reduction in a duty cycle of data transmission associated with the apparatus.

Aspect 9: The apparatus of any of Aspects 1 to 8, wherein the first security action includes disablement of communication between the apparatus and a device.

Aspect 10: A method for temperature exploit mitigation, the method comprising: determining a first temperature of an apparatus; determining the first temperature of the apparatus is within a first temperature range; adjusting a security level of the apparatus to a first security level based on the first temperature range; and performing a first security action associated with the first security level.

Aspect 11: The method of Aspect 10, further comprising: determining a second temperature associated with a change in temperature of the apparatus; determining the second temperature of the apparatus is within a second temperature range, the second temperature range associated with temperatures that are higher than temperatures of the first temperature range; adjusting the security level of the apparatus to a second security level based on the second temperature range; and performing a second security action associated with the second security level, wherein performance of the second security action uses less processing power than performance of the first security action.

Aspect 12: The method of Aspect 11, wherein the first security action and the second security action include at least one of encryption of data, partial encryption of data, authentication of data, partial authentication of data, reduction of collected data resolution, or transition of the apparatus to an idle mode.

Aspect 13: The method of any of Aspects 11 to 12, further comprising: detecting a cybersecurity attack based on a change from the first temperature to the second temperature.

Aspect 14: The method of any of Aspects 10 to 13, further comprising: determining a cooling action based on the first temperature and the first security action; and performing the cooling action.

Aspect 15: The method of any of Aspects 10 to 14, wherein the cooling action includes at least one of activation of a fan, adjustment of a fan speed, activation of direct liquid cooling, or performance of liquid immersion cooling.

Aspect 16: The method of any of Aspects 10 to 15, wherein the apparatus is a server.

Aspect 17: The method of any of Aspects 10 to 16, wherein the first security action includes a reduction in a duty cycle of data transmission associated with the apparatus.

Aspect 18: The method of any of Aspects 10 to 17, wherein the first security action includes disablement of communication between the apparatus and a device.

Aspect 19: An apparatus for temperature exploit mitigation is provided. The apparatus includes one or more means for performing operations according to any of Aspects 1 to 9.

Aspect 20: A non-transitory computer-readable medium is provided having stored thereon instructions that, when executed by at least one processor, cause the at least one processor to perform operations according to any of Aspects 10 to 18.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but is to be accorded the full scope consistent with the language claims, wherein reference to an element in the singular is not intended to mean “one and only one” unless specifically so stated, but rather “one or more.”

What is claimed is:

1. An apparatus for temperature exploit mitigation, the apparatus comprising:
at least one memory; and
at least one processor coupled to the at least one memory and configured to:
determine a first temperature of the apparatus;
determine the first temperature of the apparatus is within a first temperature range;
adjust a security level of the apparatus to a first security level based on the first temperature range; and
perform a first security action associated with the first security level.

2. The apparatus of claim 1, wherein the at least one processor is configured to:
determine a second temperature associated with a change in temperature of the apparatus;
determine the second temperature of the apparatus is within a second temperature range, the second temperature range associated with temperatures that are higher than temperatures of the first temperature range;
adjust the security level of the apparatus to a second security level based on the second temperature range; and
perform a second security action associated with the second security level, wherein performance of the second security action uses less processing power than performance of the first security action.

3. The apparatus of claim 2, wherein the first security action and the second security action include at least one of encryption of data, partial encryption of data, authentication of data, partial authentication of data, reduction of collected data resolution, or transition of the apparatus to an idle mode.

4. The apparatus of claim 2, wherein the at least one processor is configured to:
detect a cybersecurity attack based on a change from the first temperature to the second temperature.

5. The apparatus of claim 1, wherein the at least one processor is configured to:
determine a cooling action based on the first temperature and the first security action; and
perform the cooling action.

6. The apparatus of claim 5, wherein the cooling action includes at least one of activation of a fan, adjustment of a fan speed, activation of direct liquid cooling, or performance of liquid immersion cooling.

7. The apparatus of claim 1, wherein the apparatus is a server.

8. The apparatus of claim 1, wherein the first security action includes a reduction in a duty cycle of data transmission associated with the apparatus.

9. The apparatus of claim 1, wherein the first security action includes disablement of communication between the apparatus and a device.

10. A method for temperature exploit mitigation, the method comprising:
determining a first temperature of an apparatus;
determining the first temperature of the apparatus is within a first temperature range;
adjusting a security level of the apparatus to a first security level based on the first temperature range; and
performing a first security action associated with the first security level.

11. The method of claim 10, further comprising:
determining a second temperature associated with a change in temperature of the apparatus;
determining the second temperature of the apparatus is within a second temperature range, the second temperature range associated with temperatures that are higher than temperatures of the first temperature range;
adjusting the security level of the apparatus to a second security level based on the second temperature range; and
performing a second security action associated with the second security level, wherein performance of the second security action uses less processing power than performance of the first security action.

12. The method of claim 11, wherein the first security action and the second security action include at least one of encryption of data, partial encryption of data, authentication of data, partial authentication of data, reduction of collected data resolution, or transition of the apparatus to an idle mode.

13. The method of claim 11, further comprising:
detecting a cybersecurity attack based on a change from the first temperature to the second temperature.

14. The method of claim 10, further comprising:
determining a cooling action based on the first temperature and the first security action; and
performing the cooling action.

15. The method of claim 14, wherein the cooling action includes at least one of activation of a fan, adjustment of a fan speed, activation of direct liquid cooling, or performance of liquid immersion cooling.

16. The method of claim 10, wherein the apparatus is a server.

17. The method of claim 10, wherein the first security action includes a reduction in a duty cycle of data transmission associated with the apparatus.

18. The method of claim 10, wherein the first security action includes disablement of communication between the apparatus and a device.

19. A non-transitory computer-readable medium having stored thereon instructions that, when executed by at least one processor, cause the at least one processor to:
determine a first temperature of an apparatus;
determine the first temperature of the apparatus is within a first temperature range;
adjust a security level of the apparatus to a first security level based on the first temperature range; and
perform a first security action associated with the first security level.

20. The non-transitory computer-readable medium of claim 19, wherein the at least one processor is further configured to:
determine a second temperature associated with a change in temperature of the apparatus;
determine the second temperature of the apparatus is within a second temperature range, the second temperature range associated with temperatures that are higher than temperatures of the first temperature range;
adjust the security level of the apparatus to a second security level based on the second temperature range; and
perform a second security action associated with the second security level, wherein performance of the second security action uses less processing power than performance of the first security action.
